(19) United States
(12) Patent Application Publication
(10) Pub. No.: US 2004/0216274 A1
(43) Pub. Date: Nov. 4, 2004

(54) Releasable hinge clamp

(76) Inventors: Charles E. Morgan, Pittsburgh, PA (US); Eric V. Pitchford, Pittsburgh, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/427,534

(22) Filed: May 1, 2003

(51) Int. Cl. E05D 7/10

(52) U.S. Cl. 16/267

(57) ABSTRACT

A releasable hinge clamp can provide multiple functions including clamping a first releasable member adjacent a second member, holding the releasable member in a secondary position away from the second member such that generally unobstructed access to the second member is enabled, and enabling full separation of the adjacently held members. The releasable hinge clamp can have a first end rotatably attachable to the first member, a second end releasably attachable to the second member, such as by slidably capturing a cooperating portion of the second member in a slot in the second end which defines a plurality of positions whereat said second member is clamped against the first member, held at the secondary position, or positioned to be separated from the first member via an opening provided in the slot.

### BACKGROUND

The invention relates generally to a releasable clamp device to secure one member to another, and more particularly to a releasable hinge clamp which can provide multiple functions of clamping a pair of adjacently held members, holding one of the members in a secondary position away from the other member, and full separation of the members if desired.

Clamping devices for tightly securing members together, such as a lid to a vessel, are well known in the prior art. A simple example of a clamping device can be such as commonly used on articles like tool boxes and fishing tackle boxes. More particular to the present invention, it is also known to use clamping devices to releasably connect adjacently held portions of a material loading device for a plastic molding machine. The loader can commonly have a motor, such as a vacuum motor, releasably connected on top of a body portion. The upper end of the body can have an inlet connected, such as by a tube, to a material storage container from which material is drawn by the vacuum motor and delivered to the molding machine. The loader is often mounted on top of a hopper, with the bottom of the body opening into the top of the hopper, and the bottom of the hopper opening into the plasticizing portion of the molding machine. The motor creates a vacuum which draws material from a storage bin into the body via the inlet, and thence down through the body into the hopper. A filter can commonly be provided in the body portion between the inlet and the hopper. Once the material has been delivered to the hopper it is directed into the plasticizing portion of the injection molding machine.

The height of the injection molding machine and the added height of the hopper, on top of which the tube loader is mounted, can typically result in the loader being installed relatively high off of the floor of the shop. Consequently, it can be difficult to access the loader for maintenance purposes, such as to clean or change-out the filter. To service the tube loader, the vacuum motor must be moved away from the top of the body sufficiently to allow access to the filter and the inside of the loader. The conventional manner of attachment of the vacuum motor to the body is a releasable clamp type member which can be, for example, similar in configuration to clamps commonly used on tool or fishing tackle boxes. After releasing the conventional clamps, the vacuum motor would often be completely detached from the top of the loader and set aside while the inside of the throat was accessed for maintenance. If the necessary maintenance is simple, such as replacing the filter, the technician might hold the vacuum motor with one hand and change the filter with the other hand. However, the vacuum motor can weigh several pounds, and access to the top of the loader, which can require some type of ladder or stool to reach the tube loader, can make it inconvenient to hold the motor while servicing the tube loader.

Accordingly, in order to simplify and reduce the time and effort needed to service the loader, it would be preferable to have a releasable hinge clamp which can permit the vacuum motor to be released from the loader and moved into a secondary position which allows full access to the inside of the body, without fully detaching the motor from the body. Moreover, it would also be useful for the releasable hinge clamp to support the motor in that position while the tube loader was being serviced. The releasable hinge clamp could additionally be configured to permit the motor to be fully separated from the loader if desired. Although this particular application is described in detail, a releasable hinge clamp according to the invention could also find utility in other applications, for example where it would be convenient to have a clamp to hold a vessel lid in a released, out of the way, position while access to the vessel was needed.

### SUMMARY

A releasable hinge clamp can be provided having multiple function capabilities of clamping a pair of adjacent members, holding one member in a secondary position apart from the other member, and fully separating the adjacently clamped members. When closed, the releasable hinge clamp can hold the adjacent members tightly together, and when released, the hinge clamp can both support the detachable member in a secondary position and permit complete removal of the detachable member if desired. More specifically, the releasable hinge clamp can support the one member in a secondary position sufficiently away from the other member such that easy access to the second member is provided. The releasable hinge clamp can also be configured to permit complete separation of the second member from the first member when desired.

According to an embodiment of the invention, the releasable hinge clamp for accomplishing these functions can be formed from metal, and, in a certain embodiment, can be a generally flat triangular shaped member. A first end of the releasable hinge clamp can be rotatably attachable to a first member and a second end can be releasably attachable to a second member which the hinge clamp holds adjacent to the first member. The second end can have a slot therein and the second member can have a post or similar protruding member which is slidably received in the slot. The slot can define a path which the post is constrained to follow upon rotation of the hinge clamp about the connection of the first end to the first member. Certain locations along the path define certain positions at which the second member is held relative to said first member. These positions can include one at which the second member is securely clamped against the first member, and another at which the second member is supported at a secondary position away from the first member. The slot can also have an opening therein, creating a third position, a location at which the post can be removed from the slot to permit the second member to be entirely separated from the first member. The releasable hinge clamp can also include a third end which can have a portion configured for convenient manual manipulation to rotate the releasable hinge clamp about the first end. For example, the end of the third end can be flanged, e.g., angled somewhat perpendicularly to the generally flat body of the hinge clamp, so as to provide a convenient portion to pull, or push upon, to cause rotation of the hinge clamp. As the releasable hinge clamp is rotated about the rotatably attached first end, the post traces the path defined by the slot in the second end, causing the second member to be moved through the various positions described above relative to the adjacently held first member.

Other details, objects, and advantages of the invention will become apparent from the following detailed description and the accompanying drawings figures of certain embodiments thereof.

### BRIEF DESCRIPTION OF THE DRAWING FIGURES

A more complete understanding of the invention can be obtained by considering the following detailed description in conjunction with the accompanying drawings, in which:

FIG. 1 is a front view of an embodiment of a releasable hinge clamp according to the invention.

FIG. 2 is a front view of a pair of members held adjacently by a pair of releasable hinge clamps as shown in FIG. 1.

FIGS. 3 through 7 are a series of side views of the arrangement shown in FIG. 3 which illustrate how one member can be moved relative to, held in a secondary position by, and ultimately separated from, a second member using a pair of the releasable hinge clamps.

### DETAILED DESCRIPTION OF CERTAIN EMBODIMENTS

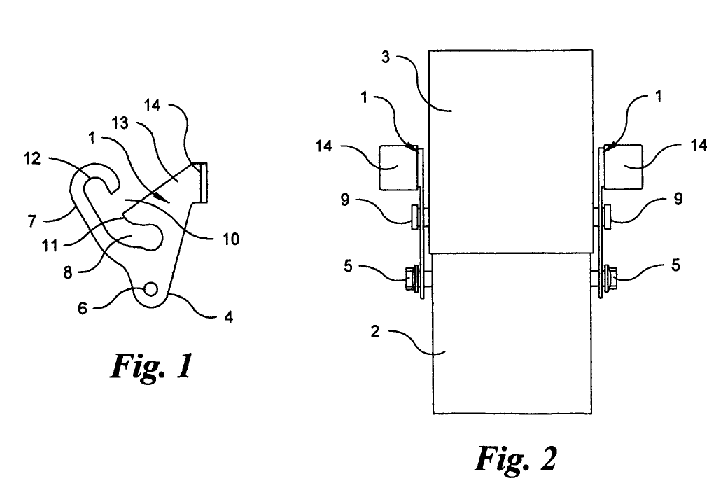

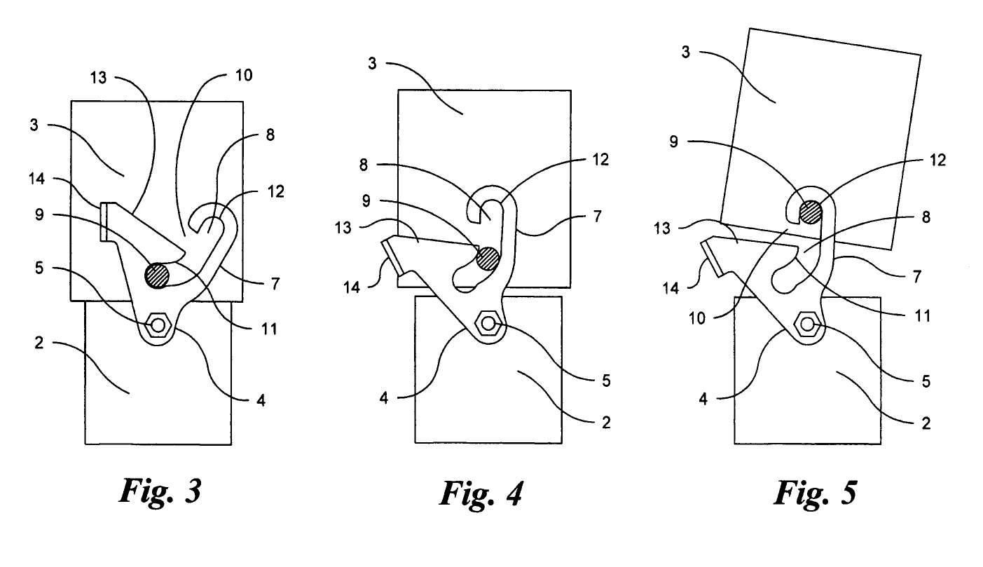

Referring now to the drawing figures wherein like reference numbers refer to similar parts throughout the several views, a releasable hinge clamp 1 according to an embodiment of the invention is shown in FIGS. 1 and 2 as a generally flat, triangular, V-shaped, or Y-shaped article. The releasable hinge clamp 1 can be formed from metal. However, it must be understood that the hinge clamp 1 could easily be formed other than flat, could be other than triangular or V-shaped, and may be made of a material other than metal. As illustrated particularly in FIG. 2, a pair of the releasable hinge clamps 1 can be used to hold a first member 2, or base vessel, adjacent a second, releasable member 3. In a particular application for the invention, the releasable member 3 and the base vessel 2 can be representative of a motor and body portion of a loader device as described previously.

A first end 4 of each generally flat hinge clamp 1 can be rotatably connected, for example by a pin 5, to the base vessel 2 via holes 6 in the sides of the base vessel 2 at each location where a clamp 1 is to be attached. A second end 7 of the hinge clamp 1 can be connected to the adjacently held releasable member 3 in a manner which permits the hinge clamp to move, and hold the releasable member 3 in a secondary position away from the base vessel 2 (see FIG. 6) such that generally unobstructed access to the base vessel 2 is provided.

In the embodiment shown, one manner of accomplishing this multifunctional connectivity is to provide a slot 8 in the second end 7 of the hinge clamp 1 and a post 9, or other similar element, on the releasable member 3 where each clamp 1 is connected. The post 9 can be slidably received in the slot 8. The slot 8 can define a path which the post 9 is constrained to follow when the releasable hinge clamp 1 is rotated about the base vessel 2. The path defined by the slot 8 thus also defines the condition of the releasable member 3 with respect to the base vessel 2. Multiple positions along the path defined by the slot 8 correspond to positions whereat the releasable member 3 is securely clamped to the base vessel 2, or whereat the releasable member 3 is held in a secondary position away from the base vessel 2 such that easy access to the inside of the base vessel 2 is permitted.

Referring particularly to FIG. 7, a further functionality of the hinge clamp 1 is the provision of an opening 10 at some point along the slot 8 which permits the releasable member 3 to be fully separated from the base vessel 2 if desired. When rotated to a position at which the post 9 aligns with the opening 10 in the slot 8, it is possible to detach the releasable member 3 from the base vessel 2 by removing the post 9 through the opening 10. The opening 10 can be provided in an upper side of the slot 8 such that full separation of the releasable member 3 will generally only occur by purposefully lifting the releasable member 3 up away from the base vessel 2. Since the releasable member 3 can be separated only when the post 9 is deliberately aligned with the opening 10 in the slot 8 through which it can be removed, the releasable member 3 can be less likely to accidentally become fully separated from the base vessel 2 when the hinge clamp 1 is rotated.

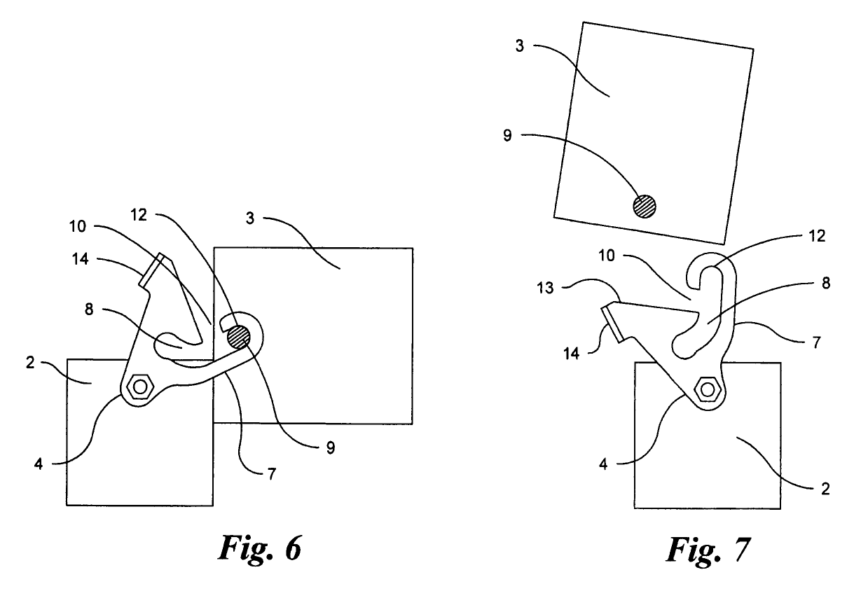

As shown best in FIGS. 3 and 4, the path defined by slot 8 can be configured to cause tightening of the releasable member 3 against the base vessel 2 when the hinge clamp 1 is fully rotated in one direction, clockwise in the embodiment shown. This can be accomplished, for example, by controlling the distance between the pin 5 which rotatably connects the hinge clamp 1 to the base vessel 2 and the post 9 on the releasable member 3. This can also be facilitated by providing the post 9 at a position on the releasable member 3 which is generally aligned in the same vertical plane as the pin 5 on the base vessel 2. Basically, the shorter the distance between the pin 5 and the post 9, the more tightly the releasable member 3 will be clamped against the base vessel 2 when the hinge clamp 1 is rotated fully clockwise. Since the path traveled by the post 9 is defined by the slot 8, the design of the slot 8 can also be manipulated to adjust the desired amount of clamping force. For example, a first portion of the slot 8 can be appropriately angled to provide a smooth transition from an unclamped position to the hinge clamped position. Also, a tightening action can be effected by an arc detail 11, which post 9 is constrained to follow because it is captured in the slot 8, as the hinge clamp 1 is rotated. As the hinge clamp 1 is rotated clockwise, with post 9 captured the slot 8, arc detail 11 forces the post 9 down, creating a tightening action between the post 9 on the releasable member 3 and the pin 5 on the base vessel 2. Arc detail 11 thus essentially pulls the releasable member 3 against the base vessel 2.

When the hinge clamp 1 is rotated counterclockwise, in the embodiment shown, the path defined by the slot 8 can be configured to cause, or permit, the releasable vessel 2 to first be unclamped from the base vessel 2. Next, the releasable member 3 can be moved away from the base vessel 2 to the extent permitted by the length of the slot 8. Finally, the releasable member 3 can be swung away from its position over top of the base vessel 2 to the aforementioned secondary position where it can be securely held by the hinge clamp 1 which permits the base vessel 2 to be easily accessed. In the embodiment shown, for example, the hinge action of the hinge clamp 1 can be provided by path detail 12, which allows post 9 to travel a defined distance from the tightening position created by arc detail 11 at the opposite end of the slot 8. In path detail 12, the slot 8 can also be wider than at the arc detail 11, such that the post 9 can slide loosely enough to allow the releasable member 3 to move freely and be repositioned by the user to the secondary position. The particular positioning at which the releasable member 3 is held in the aforesaid secondary position can be a function of design factors such as the length and/or shape of the slot 8. For example, it can be understood that if the slot is made longer, the releasable member 3 can be displaced further from the base vessel 2. Generally, the shape, e.g., angle, of the slot 3 and, or, its position relative to the rotation point of the first end 4, i.e., the pin 5, can also be manipulated to affect the position of the releasable member 3 relative to the base vessel 2 in the secondary position.

The releasable member 2 can be supported by the hinge clamp 1 at the secondary position without being fully separated from the base vessel 2. This can be a very desirable feature in cases where the base vessel 2 is mounted at a relatively high position such that a ladder, or other device to provide access to a higher position, is needed to access the base vessel 2. Although rotated out of the way to a secondary position, the releasable member 3 can be securely held by the releasable hinge clamps 1 so that it is not be necessary for a technician to hold the releasable member 3, or to fully separate and set it aside, while the base vessel 2 is being serviced. However, the releasable hinge clamps 1 can still permit the releasable member 3 to be entirely removed from the base vessel 2 and set aside if desired. Accordingly, if the base vessel 2 were the body of a loader, and the releasable member 3 were the motor, the body (2) would be easily accessible for servicing or cleaning while the motor (3) was securely held in the secondary position by the releasable hinge clamps 1.

As illustrated best in FIG. 2, a third end 13 of the hinge clamp 1 can further be configured to facilitate manual operation, i.e., rotation, of the hinge clamp to control the position of the releasable member 3. In the embodiment shown, a distal end of the third end 13 can have a flanged portion 14, e.g., bent over at an angle to the otherwise generally flat clamp 1. This flanged portion 14 can provide a convenient portion for gripping by hand, to either push or pull, the third end 13 of the hinge clamp 1 to cause rotation of the hinge clamp 1 about the first end 4 to tighten or loosen the releasable member 3 relative to the base vessel 2.

As described above, the releasable hinge clamp 1 provides multiple functionality in a single, unitary device. Conventionally, multiple clamping and holding devices would be required to provide this multiple functionality. In the prior art, multiple conventional clamping and retaining devices would be individually needed to provide the same combination of functions which are all provided by the single releasable hinge clamp. For example, to provide similar functional capability provided by the releasable hinge clamp, the following conventional devices could be required: an over-center clamp, a separate hinging device, and a releasable hinge pin or other disconnection method. Besides the obvious drawbacks of having to use more than one device, another disadvantage associated with multiple devices is that user orientation must change to interact with the plurality of devices, in contrast to a single interaction device like the releasable hinge clamp. Consequently, the releasable hinge clamp can effectively replace multiple prior art type clamp devices that have been used in the past perform these functions separately. The releasable hinge clamp 1 can thereby simplify the hardware associated with common interaction of adjacently clamped members, for example vessels and lids, and can make the performance of common functions more intuitive to the user. The releasable hinge clamp 1 differs from conventional devices in simplicity, low cost, and multiple function capability.

As described, the releasable hinge clamps 1 can provide multiple functions of clamping, holding in a secondary position, and full separability of a releasable top member from a base vessel member in a single, relatively simple device. Moreover, although only described herein generally in the context of a vacuum motor connected to the body of a loader for a plastic molding machine, it will be apparent to those of ordinary skill in the art that a releasable hinge clamp 1 as taught in this disclosure can be easily adapted for use in other applications. For example, such releasable hinge clamps can be similarly employed to connect any adjacently held members where it would be desirable to clamp the members, or hold the members in a separated position away from each other, and also provide the option to fully separate both members.

Because the releasable hinge clamp 1 embodies such simplicity of design, low cost, and excellent design flexibility, it should be understood that other embodiments of the invention can easily be derived by those of ordinary skill in the art for use in other applications that are in need of similar integrated clamp, hinge and release features. For example, any lid, door, or other one of a pair of adjacently held members could be served by variations of this concept by shrinking or enlarging the releasable hinge clamp 1, lengthening, shortening, or reconfiguring the slot 8, i.e., path of travel, including enlarging or shrinking the size of the slot 8 to accommodate various different sizes, weights and geometry of other adjacently positioned members. The configuration, and/or number of path detail portions 11, 12 of the slot 8 can likewise be raised to provide different features or adapted for different applications. Some possible other applications for such hinge clamp 1 can include access doors, vessel lids, bulkhead connectors for air, liquids, electrical or communication, mating machinery components, filter chamber lids, storage container covers, and the like.

Therefore, although certain embodiments of the invention have been described in detail, it will be appreciated by those skilled in the art that various modifications to those details could be developed in light of the overall teaching of the disclosure. Accordingly, the particular embodiments disclosed herein are intended to be illustrative only and not limiting to the scope of the invention which should be awarded the full breadth of the following claims and any and all embodiments thereof.

What is claimed is:

1. A releasable hinge clamp for first and second members, said releasable hinge clamp comprising:
a first end rotatably engageable with said first member;
a second end releasably and movably engageable with said second member such that said second member may be moved through a plurality of positions relative to said first member;
rotation of said second end about said first end causing said second member to move through said plurality of positions; and
said plurality of positions being at least one of positions whereat said second member is clamped against said first member and whereat said second member is held at a position away from said first member which enables generally unobstructed access to said first member.

2. The releasable hinge clamp of claim 1 further comprising:
said second member having a pin;
said second end having a slot in which said pin is slidably engageable;
said slot having an opening by which said pin is removable from said slot; and
said plurality of positions further being a position whereat said second member can be detached from said first member by removing said pin through said opening in said slot.

3. The releasable hinge clamp of claim 1 further comprising a third end, manipulation of which causes rotation of said hinge clamp about said first end.

4. The releasable hinge clamp of claim 3 further comprising said releasable hinge clamp being a generally flat article and said third end having a flanged portion.

5. A material loading device for a plastic molding machine comprising:
first and second members of said loading device connected via a releasable hinge clamp;
said releasable hinge clamp having a first end rotatably connected to said first member and a second end releasably connected to said second member, said second end having a slot therein;
said second member having a pin slidably received in said slot;
said slot defining a path traveled by said pin upon rotation of said releasable hinge clamp about said first end thereof; and
a plurality of locations along said path corresponding to positions of said pin whereat said second member is at least one of held securely against said first member and supported in a position away from said first member which enables generally unobstructed access to said first member.

6. The material loading device of claim 5 further comprising
said slot having an opening to permit separation of said second member from said first member; and
said plurality of positions including a position whereat said pin is aligned with said opening in said slot such that said pin can be removed from said slot and thus said second member can be separated from said first member.

7. The material loading device of claim 5 further comprising said releasable hinge clamp having a third end, manipulation of which causes rotation of said hinge clamp about said first end.

8. The releasable hinge clamp of claim 7 further comprising said releasable hinge clamp being a generally flat article and said third end having a flanged portion.
